(19) United States
(12) Patent Application Publication
(10) Pub. No.: US 2026/0212523 A1
(43) Pub. Date: Jul. 23, 2026

(54) SYSTEMS AND METHODS FOR IMAGE-BASED DIMENSIONING OF OBJECT IN MERGED POINT CLOUD

(71) Applicant: COGNEX CORPORATION, Natick, MA (US)

(72) Inventor: Nitin VAIDYA, Shrewsbury, MA (US)

(21) Appl. No.: 19/456,479

(22) Filed: Jan. 22, 2026

Related U.S. Application Data
(60) Provisional application No. 63/748,177, filed on Jan. 22, 2025.

(51) Int. Cl. G06T 7/60; G06T 7/246; G06T 7/254

(52) U.S. Cl. CPC G06T 7/60; G06T 7/246; G06T 7/254; G06T 2200/04; G06T 2207/10012; G06T 2207/10028; G06T 2207/20221; G06T 2207/30244

(57) ABSTRACT

Systems and associated methods implement or perform obtaining merged point cloud data that includes a composite image data based on a plurality of three-dimensional (3D) images using a 3D camera assembly as the object is moved along the transport device; determining a first dimension of the object and a second dimension of the object based on a positive 3D image data of the merged point cloud data; and determining a third dimension of the object, including: determining a width of the object along a lateral direction intersecting a direction of motion of the transport device based on the composite image data and a width of a negative 3D image data.

### CROSS-REFERENCE TO RELATED APPLICATIONS

This application claims priority to and the benefit of U.S. Provisional Application No. 63/748,177, filed Jan. 22, 2025, the entire contents of which are herein incorporated by reference for all purposes.

### STATEMENT REGARDING FEDERALLY FUNDED RESEARCH

Not applicable.

### BACKGROUND

Machine vision systems, also termed “vision systems” herein, are used to perform a variety of tasks (such as measurement, inspection, alignment of objects, or decoding of symbology) in a wide range of applications and industries, including a manufacturing environment. In general, a vision system consists of one or more cameras with an image sensor (or “imager”) that acquires grayscale or color images of a scene that contains an object or surface of interest. Images of the object/surface can be analyzed to provide data/information to users and associated manufacturing processes. The data produced by the image is typically analyzed and processed by the vision system in one or more vision system processors that can be purpose-built, or part of one or more software application(s) using either conventional or deep learning/AI-based processes, instantiated within a general purpose computer (e.g. a PC, laptop, tablet or smartphone), or a custom processor. Some types of tasks performed by the vision system can include inspection of objects and surfaces, such as those residing on a moving conveyor arrangement or motion stage, for expected features or defects.

### SUMMARY

In an aspect, the present disclosure provides a vision system for dimensioning an object acted upon by a transport device. The system comprises a memory; and at least one processor operatively connected to the memory and configured to receive merged point cloud data corresponding to at least a first three-dimensional (3D) image and a second 3D image acquired using a 3D camera assembly, the merged point cloud data including a connected composite blob data formed of positive 3D image data and negative 3D image data, receive camera pose data including a known pose of the 3D camera assembly, and determine a width of the object along a first object direction intersecting a direction of motion of the transport device based on at least: the connected composite blob data, a first scalar distance between a representation of the object in the merged point cloud data and a representation of the object in the first 3D image, and a second scalar distance between the representation of the object in the merged point cloud data and a representation of the object in the second 3D image.

In another aspect, the present disclosure provides a method of dimensioning an object acted upon by a transport device. The method comprises generating merged point cloud data that includes a composite image data based on a plurality of three-dimensional (3D) images using a 3D camera assembly as the object is acted upon by the transport device; determining a first dimension of the object and a second dimension of the object based on a positive 3D image data of the merged point cloud data; and determining a third dimension of the object along a lateral direction intersecting a direction of motion of the transport device based on the composite image data and a width of a negative 3D image data of the merged point cloud data.

Other features, objects, and advantages of the presently disclosed technology are apparent in the detailed description that follows. It should be understood, however, that the detailed description, while indicating embodiments of the presently disclosed technology, is given by way of illustration only, not limitation. Various changes and modifications within the scope of the disclosed technology will become apparent to those skilled in the art from the detailed description.

### BRIEF DESCRIPTIONS OF THE DRAWINGS

FIG. 1 illustrates an example vision system arrangement according to various aspects of the present disclosure.

FIG. 2 illustrates an example image according to various aspects of the present disclosure.

FIG. 3A illustrates an example view of an object in an image according to various aspects of the present disclosure.

FIG. 3B illustrates an example view of an object in an image according to various aspects of the present disclosure.

FIG. 4 illustrates an example view of an object in a merged point cloud according to various aspects of the present disclosure.

FIG. 5 illustrates an example imaging method according to various aspects of the present disclosure.

### DETAILED DESCRIPTION

In a vision system, one or more vision system camera(s) can be arranged to acquire two-dimensional (2D) or three-dimensional (3D) images of objects in an imaged scene. 3D image information may be present in the form of a point cloud. However, the 3D dimensions of objects of challenging reflectivity, such as packs of water bottles wrapped in transparent plastic, may be difficult to find from the corresponding 3D image point clouds. For example, typically, only a fraction of the top surface of such objects yields location data when imaged by 3D cameras. As such, significant portions of the 3D data may be absent from the point cloud.

Comparative techniques may be used to dimension such an object when the acquired point cloud corresponds to a single snapshot from a 3D camera. However, these methods may present difficulties when the point cloud is the result of merging multiple snapshots acquired while the object is moving along a transport device, such as a conveyor. Among other benefits, the present disclosure addresses these and other shortcomings in the comparative techniques, and sets forth systems and methods that can determine dimensions of objects with challenging reflectivity even when corresponding point clouds are formed by merging multiple snapshots acquired as the object is in motion.

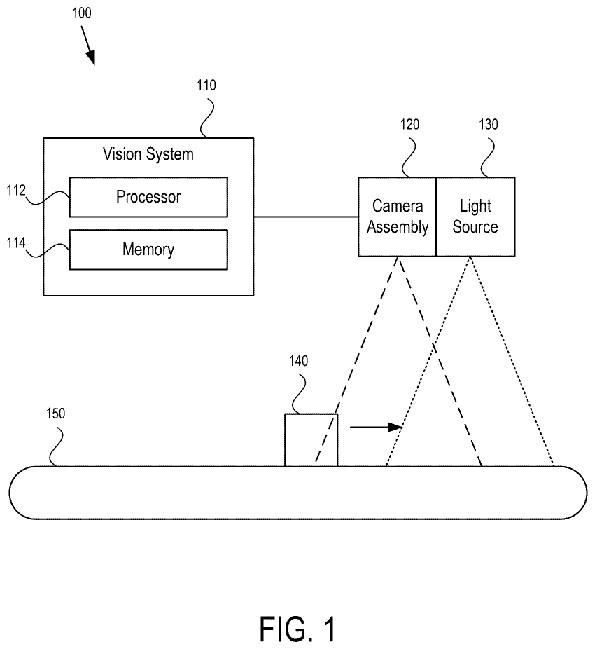

FIG. 1 shows an overview of an arrangement 100 in which a vision system 110 is operatively connected to a vision system imaging assembly 120 (also termed a “camera assembly” or simply “camera”) associated with a light source 130. The imaging assembly 120 acquires three-dimensional (3D) image data of a series of objects 140 (of which only one is shown for ease and clarity of explanation) as they pass beneath its field of view (FOV) with respect to a transport device 150 in a direction of motion, shown by an arrow. In the illustrated example, the transport device 150 is a conveyor having a moving upper surface on which the objects 140 are disposed, although other transport devices can be used in other examples as variously known in the art. It should be noted that any arrangement of one or more objects can be imaged and analyzed according to the system and method set forth herein, and that any object(s) may have one or more complex surfaces.

The imaging assembly 120 may be any assembly that acquires 3D images of objects, including but not limited to stereo cameras, time-of-flight cameras, light detection and ranging (LiDAR) cameras, ultrasonic range-finding cameras, structured illumination systems (e.g., structured illumination-based cameras), laser displacement sensors (profiles), and the like. Accordingly, the terms camera and 3D camera should be taken broadly to include these systems and any other system that generates height in association with a two-dimensional (2D) image of an object. A single camera or an array of a plurality of cameras may be provided, and the terms “camera” or “camera assembly” can refer to one or more cameras that acquire image(s) in a manner that generates the desired 3D image data for the scene. In the illustrated example, the imaging assembly 120 is shown mounted to overlie the surface of the transport device 150 in the manner of a checkpoint or inspection station that images the flowing objects as they pass by. The object(s) 140 can remain in motion or stop momentarily for imaging, depending on the operating speed of the conveyor and the acquisition time for the image sensor of the camera and related electronics (which may depend, in part, on various settings such as frame rate and aperture). In the illustrated example, the imaging assembly 120 defines an optical axis that is approximately normal (perpendicular) to the upper surface of the transport device 150. However, in other implementations the optical axis can be oriented at a non-perpendicular angle with respect to the surface of the transport device 150.

The imaging assembly 120 may include an image sensor that is adapted to generate 3D image data internal to its housing. A light source 130 for the imaging assembly 120 may be configured as an internal light source of the imaging assembly 120 or as an external light source to which the imaging assembly 120 may be operatively connected to (e.g., mounted with, in communication with). In one particular example, the light source 130 may be in the form of a pattern projector that projects light in a known (e.g., predetermined) pattern. Thus, while FIG. 1 shows the imaging assembly 120 and the light source 130 as being adjacent to one another such that the FOV of the imaging assembly 120 and the projection field of the light source 130 are offset, other physical configurations are within the scope of the present disclosure. The imaging assembly 120, light source 130, or both may further be equipped or associated with additional optical components.

The imaging assembly 120 is in communication with a processor 112 or a memory 114 of the vision system 110. Thus, the vision system 110 receives image data from the imaging assembly 120 and performs various vision system tasks upon the data in accordance with the systems and methods set forth herein. The processor 112 may include underlying processes/processors/cores or functional models, including a set of vision system tools, which can comprise a variety of standard or custom tools that identify and analyze features in image data, including but not limited to edge detector tools, blob tools, pattern recognition tools, deep learning networks, and the like. The processor 112 of the vision system 110 may further include a dimensioning processor in accordance with the systems and methods described herein. The dimensioning processor may perform various analysis and measurement tasks on features identified in the 3D image data so as to determine the presence of specific features from which further results can be computed. The processor 112 may further use a variety of standard or custom (e.g., 3D) vision system tools, which may include a 3D blob tool in some examples.

Display of system setup and results can be handled by the vision system 110 itself or by a separate computing device, such as a server (e.g., cloud-based or local), PC, laptop, tablet, or smartphone. The vision system 110 or separate computing device may have various interface components, such as a touchscreen, a keyboard, a mouse, etc., which collectively provide for user interface functionality, including through a graphical user interface (GUI). A variety of interface devices or form factors can be provided in other examples. The GUI can be driven, at least in part, by a web browser application, which may reside over a device operating system and display web pages with control and data information from the processor 112 in accordance with various examples.

In some implementations, the processor 112 or the memory 114 can reside fully or partially on-board the housing of the imaging assembly 120, and various process modules or tools (e.g., the dimensioning tool, the blob tool, etc.) can be instantiated entirely or partially in either the processor 112 or the separate computing device as appropriate. In one particular example, all vision system and interface functions can be instantiated on the processor 112, and the separate computing device can be employed primarily for training, monitoring, and related operations with interface web pages (e.g., HTML) generated by the processor 112 and transmitted to the computing device via a wired or wireless network link. Alternatively, part or all of the processor 112 can reside in the separate computing device. In any case, results from analysis by the processor 112 can be transmitted to a downstream utilization device or process. Such device/process can use results to control handling of objects (e.g., the object 140), for example gating the transport device 150 to direct objects to different destinations based upon analyzed features or to reject defective objects.

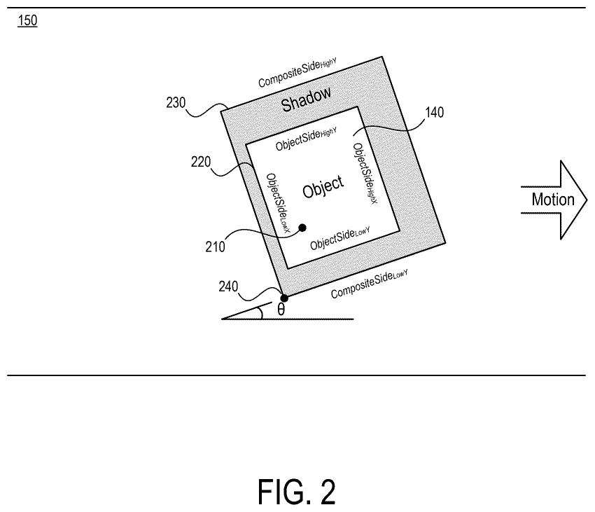

FIG. 2 illustrates an example of a top view of the object 140 traveling along a surface of the transport device 150 in a direction of motion shown by an arrow. In this illustrated example, the imaging assembly 120 is positioned above the point 210 on the surface of the transport device 150, and therefore under the object 140. In particular, the point 210 corresponds to the origin (0, 0, 0) of a camera coordinate system (x, y, z) in which the x-direction is in the direction of motion of the surface of the transport device 150, the y-direction is transverse across the surface of the transport device 150, and the z-direction is normal to the surface of the transport device. If the imaging assembly 120 is located a height H above the surface of the transport device 150, then the coordinates of the imaging assembly 120 in the camera coordinate system is (0, 0, H). As can be seen in FIG. 2, the object 140 is rotated with respect to the camera coordinate system by an angle θ. From this, an object coordinate system (X, Y, Z) may be defined in which the X-direction is parallel to the edge of the object 140 along the direction of motion of the surface of the transport device 150, the Y-direction is parallel to the edge of the object 140 transverse to the direction of motion of the surface of the transport device 150, and the Z-direction is normal to the surface of the transport device (and thus parallel to the z-direction). The origin of the object coordinate system may be defined such that the point 240 corresponds to (X₀, Y₀, 0).

The object 140 has an object footprint 220 in the x-y plane (which is coincident with the X-Y plane). For illumination at least partly from above (as is the case with the light source 130), the object will cast a shadow as shown by the shadow footprint 230 in the x-y plane. The shadow is the result of the raised bulk of the object 140 preventing illumination (e.g., from the imaging system, from the light source 130, etc.) from reaching regions of the transport device 150 adjoining the object 140. Moreover, other areas may exist where no image data is collected (e.g., due to occlusion of the camera's FOV by portions of the object 140), further contributing to the shadow footprint 230.

For an object of challenging reflectivity, the location data points of only a fraction of the object's top surface make their way to the 3D point cloud. In some cases, these sparse data points from the top of the object 140 are sufficient to directly yield a usable estimate of the height (i.e., the dimension in the z-direction) of the object 140. If the 3D point cloud is the result of merging multiple snapshots of the object 140 acquired at different positions of the FOV, however, the data points may not be directly used to determine the length and width (i.e., the dimensions in the x- and y-directions). In such situations, using the comparative techniques, the resulting determinations of the lateral dimensions of the object 140 are likely to be significant underestimates of their true values.

Thus, the systems and methods of the present disclosure provide for more accurate dimensioning of objects moving along the surface of a transport device, often at high speeds. Moreover, due to these high speeds, it is generally impractical or impossible to perform remedial actions necessary to permit application of the comparative techniques. For example, if one were to consider forming an additional point cloud from one of the contributing snapshots and invoke the blob tool to extract another composite blob, thereby to apply the comparative technique, the dimensioning system may become unable to keep up with the high rate of passage of objects through the dimensioning system. The present disclosure can eliminate the need to form such an additional point cloud and thereby the need to incur the significant burden of an additional application of the blob tool to find the dimensions of challenging-reflectivity objects. In addition to permitting higher object throughput, this can result in a substantial decrease in computing (e.g., processing) overhead for a given object throughput.

In particular, the systems and methods set forth herein model the relationship between the spatial extent of the shadow cast by the object 140 at different positions in the FOV of the imaging assembly 120 and the spatial extent of the shadow in the merged point cloud. The inputs to the model, according to the example set forth below, are the known position and size of the composite blob in the merged point cloud, the known pose of the camera, and the known pose of the light source. The outputs from the model are the two previously unknown amounts by which the dimensions of the composite blob bounding box (or other blob spatial boundary) are enlarged by the shadow cast by the object 140 in the merged point cloud. Subtracting these values out yields the dimensions of the object 140.

Invoking the blob tool on a point cloud of the scene shown in FIG. 2 yields a composite blob that is the aggregation of the object footprint 220 and the shadow footprint 230. Four sides of the object footprint 220 are labeled in FIG. 2. Of the four sides of the object 140, one pair of opposite sides has an orientation that is closer to the x-axis; these sides are labeled as ObjectSide_{LowY} and ObjectSide_{HighY}. The angle these sides make with the axis is 0. The other pair of opposite sides has an orientation that is closer to the y-axis; these sides are labeled as ObjectSide_{Lowx} and ObjectSide_{HighX}. Additionally, two sides of the shadow footprint 230 are labeled. Of the four sides of the shadow, one pair of opposite sides has an orientation that is closer to the x-axis; these sides are labeled as CompositeSide_{LowY} and CompositeSide_{HighY}.

As used herein, areas of negative 3D image data refer to areas where 3D image data is absent. Data may be absent in an area because of shadows formed by the object 140 occluding illumination from the light source 130, because of a lack of a clear line of sight to the area from the imaging assembly 120, or because 3D image data is not successfully captured due to optical effects such as specular reflections, transparent or translucent material, spatially variable reflectivity, or other reasons. The remaining areas, where 3D image data is present, are referred to as areas of positive 3D data. These areas include the portion of the object footprint 220 where 3D image data is successfully captured and the surface of the transport device 150 outside of the areas of negative 3D image data.

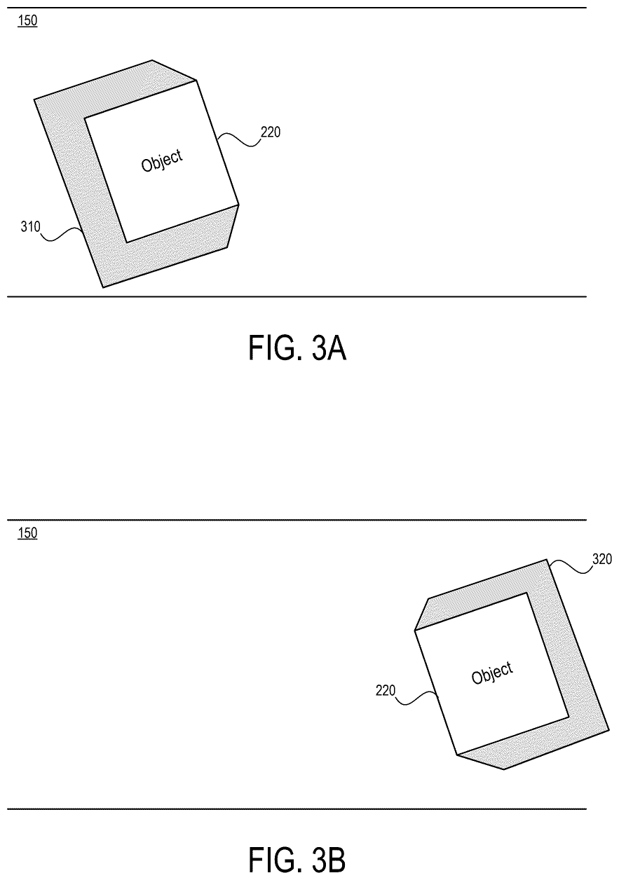

As the object 140 enters the FOV of the imaging assembly 120 at one border of the FOV, passes through a position underneath the imaging assembly 120, and exits at the opposite border of the FOV, a sequence of snapshots is captured. The outline of the shadow (i.e., the shadow footprint 230) cast by the object 140 in different snapshots is, in general, different due to the different positioning of the object relative to the imaging assembly 120 and the light source 130. This is depicted in FIGS. 3A and 3B, in which FIG. 3A shows a hypothetical first snapshot in the image sequence and FIG. 3B shows a hypothetical second snapshot in the image sequence. Below, the second snapshot will be referred to as the “last” snapshot. However, the second snapshot is not necessarily the last snapshot in time sequence (e.g., the final snapshot including the object 140 or a portion thereof).

For the sides of the object 140 having an orientation that is closer to the y-axis, the width of the shadow may either monotonically increase or else monotonically decrease across the image sequence. In the illustrated example, the leading edge (ObjectSide_{HighX}) of the object footprint 220 does not cast a shadow in the first snapshot of FIG. 3A as well as in (perhaps) the first few snapshots. Thus, the initial shadow footprint 310 surrounds only three sides of the object footprint 220. The shadow cast from the leading edge (ObjectSide_{HighX}) progressively increases in subsequent snapshots, until it has a comparatively large width in the last snapshot of FIG. 3B. The converse holds true for the width of the shadow of the trailing edge (ObjectSide_{LowX}) of the object footprint 220. Thus, the final shadow footprint 320 surrounds a different set of three sides of the object footprint 220.

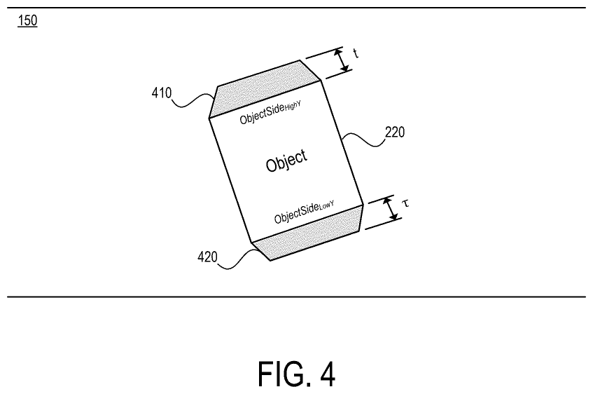

FIG. 4 illustrates an example of a merged point cloud formed by merging the point cloud data from the first snapshot of FIG. 3A, the last snapshot of FIG. 3B, and any intermediate snapshots. In the merged point cloud, the presence of contributions from snapshots where the shadow width is zero leads to the width of shadows abutting the leading and lagging edges (ObjectSide_{HighX} and ObjectSide_{LowX}) of the object footprint 220 being zero. Thus, it can be seen that, in the merged point cloud, the width of the shadow abutting a given side of the object footprint 220 is no greater than the minimum of the width values of the shadows abutting that side in the contributing snapshots. In other words, the width of the shadow footprint in FIG. 4 must be no greater than the minimum of the width of the shadow footprint 310 of FIG. 3A along the leading edge and no greater than the minimum width of the shadow footprint 320 of FIG. 3B along the trailing edge. For the two other sides, labeled ObjectSide_{HighY} and ObjectSide_{LowY} in FIG. 2, the dimension of the adjoining shadow may or may not shrink to zero in one of the contributing snapshots. FIG. 4 illustrates the case where the dimension does not shrink to zero, and instead has a first shadow footprint portion 410 along the side ObjectSide_{HighY} and a second shadow footprint portion 420 along the side ObjectSide_{LowY}. Even in this case, the dimension of the corresponding shadow footprint portion (t for portion 410; t for portion 420) is the minimum of the dimension values in the contributing snapshots.

The dimensions of the first and second shadow footprint portions 410 and 420 may be determined by applying a model to the merged point cloud data. Quantities involved in the model of the shadows, many of which are illustrated in FIGS. 2-4, are briefly described here. As noted above, the origin of the camera coordinate system (x, y, z) is considered to be the point 210 on the surface of the transport device 150 directly beneath the imaging assembly 120. Thus, the location of the imaging assembly 120 is (0, 0, H). The 3D bounding box of the composite blob of the object and its shadow in the merged point cloud is denoted by B. The object footprint 220, and the shadow footprint portions 410 and 420 correspond to a 2D rectangular face of the bounding box B in the plane of the transport device 150, and is denoted as R. The 3D dimensions of B are denoted as {l, w, h}, where l and w represent the dimensions of R, and h is the height of B above the plane of the transport device 150.

Of the four sides of R, one pair of opposite sides has an orientation that is closer to the x-axis. As above, these two sides are denoted as CompositeSide_{LowY} and CompositeSide_{HighY}. The angle these sides make with the x-axis is 0. Without loss of generality, the dimension of Composite Side LowY and Composite Side HighY is denoted as l. The other dimension of R is denoted as w. As noted above, the coordinates of the endpoint 240 of CompositeSide_{LowY} that has a lower x-value are (X₀, Y₀, 0). The scalar distance between the position of the object 140 in the first snapshot contributing to the merged point cloud and the position of the object 140 in the merged point cloud (e.g., the distance between the object 140 in FIG. 3A and FIG. 4) is denoted Tₐ. The scalar distance between the position of the object 140 in the last snapshot contributing to the merged point cloud and the position of the object 140 in the merged point cloud (e.g., the distance between the object 140 in FIG. 3B and FIG. 4) is denoted T_{b}. Both Tₐ and T_{b} are positive values. The unknown width of the shadow abutting ObjectSide_{HighY} is denoted t and the unknown width of the shadow abutting ObjectSide_{LowY} is denoted τ.

As detailed below, the model can relate shadow widths in the merged point cloud to what they would be in the first and last contributing snapshots. Notably, the model applies regardless of the orientation of the object 140 in the 2D space of the surface of the transport device 150 (i.e., the model can apply regardless of the value of θ).

First, the shadow abutting ObjectSide_{HighY} in the first contributing snapshot is modeled. This width tₐ is non-zero only if (X₀−Tₐ)sin θ<(Y₀ cos θ+w). Under this condition, the relationship of tₐ to the corresponding width t in the merged point cloud is given by the following expression (1):

$${t}_{a} = \frac{h}{H - h} ( {Y}_{0} cos θ - {X}_{0} sin θ + w + {T}_{a} sin θ - t ) \qquad ( 1 )$$

Next, the shadow abutting ObjectSide_{HighY} in the last contributing snapshot is modeled. This width t_{b} is non-zero only if (X₀+T_{b})sin θ<(Y₀ cos θ+w). Under this condition, the relationship of t_{b} to the corresponding width t in the merged point cloud is given by the following expression (2):

$${t}_{b} = \frac{h}{H - h} ( {Y}_{0} cos θ - {X}_{0} sin θ + w - {T}_{b} sin θ - t ) \qquad ( 2 )$$

In practical situations, the object 140 is likely to be laid down on the surface of the transport device 150 such that the side with the largest dimension is on the x-y plane. For the less-common case where the object 140 is stood up on the surface of the transport device 150, a quadratic equation At²+Bt+C=0 may be derived for t, according to the following definitions.

$$A = 2 {X}_{0} cos θ + 2 {Y}_{0} sin θ + 2 l + ( {T}_{b} - {T}_{a} ) cos θ$$

$$B = - [ ( {X}_{0} - w sin θ + {T}_{b} ) ( {Y}_{0} + l sin θ + w cos θ ) + ( {Y}_{0} + w cos θ ) ( {X}_{0} + l cos θ - w sin θ - {T}_{a} ) ] cos 2 θ - [ ( {Y}_{0} + w cos θ ) ( {Y}_{0} + l sin θ + w cos θ ) - ( {X}_{0} - w sin θ + {T}_{b} ) ( {X}_{0} + l cos θ - w sin θ - {T}_{a} ) ] sin 2 θ - l ( 2 {Y}_{0} + 2 w cos θ + l sin θ ) cos θ - l ( 2 {X}_{0} - 2 w sin θ + l cos θ + {T}_{b} - {T}_{a} ) sin θ$$

$$C = l ( {Y}_{0} + w cos θ ) ( {Y}_{0} + l sin θ + w cos θ ) {cos}^{2} θ - \frac{l}{2} [ ( {Y}_{0} + w cos θ ) ( {Y}_{0} + l sin θ + w cos θ ) - ( {X}_{0} - w sin θ + {T}_{b} ) ( {X}_{0} + l cos θ - w sin θ - {T}_{a} ) ] sin 2 θ + l ( {X}_{0} - w sin θ + {T}_{b} ) ( {X}_{0} + l cos θ - w sin θ - {T}_{a} ) {sin}^{2} θ$$

The shadow abutting ObjectSide_{LowY} in the first contributing snapshot is then modeled. This width τₐ is non-zero only if (X₀−Tₐ)sin θ>Y₀ cos θ. Under this condition, the relationship of τₐ to the corresponding width τ in the merged point cloud is given by the following expression (3):

$${τ}_{a} = \frac{h}{H - h} ( {X}_{0} sin θ - {Y}_{0} cos θ - {T}_{a} sin θ - τ ) \qquad ( 3 )$$

Next, the shadow abutting ObjectSide_{LowY} in the last contributing snapshot is modeled. This width τ_{b} is non-zero only if (X₀+T_{b})sin θ>Y₀ cos θ. Under this condition, the relationship of τ_{b} to the corresponding width τ in the merged point cloud is given by the following expression (4):

$${τ}_{b} = \frac{h}{H - h} ( {X}_{0} sin θ - {Y}_{0} cos θ + {T}_{b} sin θ - τ ) \qquad ( 4 )$$

For the less-common case where the object 140 is stood up on the surface of the transport device 150, another quadratic equation A′π²+B′τ+C′=0 may be derived for t, according to the following definitions.

$${A}^{′} = - ( {T}_{a} - {T}_{b} ) cos θ$$

$${B}^{′} = - {Y}_{0} ( {T}_{a} + {T}_{b} ) + l ( {X}_{0} - {T}_{a} ) sin θ - {lY}_{0} cos θ$$

$${C}^{′} = l [ ( {X}_{0} + \frac{{T}_{b} + {T}_{a}}{2} ) {Y}_{0} sin 2 θ - {X}_{0} ( {X}_{0} + {T}_{b} - {T}_{a} ) {sin}^{2} θ - {Y}_{0}^{2} {cos}^{2} θ$$

Based on the above-described model, the shadow widths t and τ are obtained according to the following operations. First, a pair of intermediate values t₁ and t₂ are calculated according to the following expressions (5a) and (5b).

$${t}_{1} = max \{ \frac{h}{H} ( {Y}_{0} cos θ - {X}_{0} sin θ + w + {T}_{a} sin θ ) , 0 \} \qquad ( 5 a )$$

$${t}_{2} = max \{ \frac{h}{H} ( {Y}_{0} cos θ - {X}_{0} sin θ + w + {T}_{b} sin θ ) , 0 \} \qquad ( 5 b )$$

If both t₁ and t₂ are greater than 0, another pair of intermediate values t₃ and t₄ are calculated according to the roots of a quadratic equation according to the following expressions (5c) and (5d), with A, B, and C as defined above.

$${t}_{3} = \frac{- B + \sqrt{{B}^{2} - 4 A C}}{2 A} \qquad ( 5 c )$$

$${t}_{4} = \frac{- B - \sqrt{{B}^{2} - 4 A C}}{2 A} \qquad ( 5 d )$$

If t₃ is either non-real or negative, t₃ is then set equal to t₁. Similarly, if t₄ is either non-real or negative, t₄ is set equal to t₁. From these expressions, the dimension of the shadow abutting ObjectSide_{HighY} is given by the following expression (6).

$$t = min \{ {t}_{1} , {t}_{2} , {t}_{3} , {t}_{4} \} \qquad ( 6 )$$

After this, the value of t is obtained. This operation begins by calculating a pair of intermediate values τ₁ and τ₂ are calculated according to the following expressions (7a) and (7b).

$${τ}_{1} = max \{ \frac{h}{H} ( {X}_{0} sin θ - {Y}_{0} cos θ + {T}_{a} sin θ ) , 0 \} \qquad ( 7 a )$$

$${τ}_{2} = max \{ \frac{h}{H} ( {X}_{0} sin θ - {Y}_{0} cos θ + {T}_{b} sin θ ) , 0 \} \qquad ( 7 b )$$

If both τ₁ and τ₂ are greater than 0, another pair of intermediate values τ₃ and τ₄ are calculated according to the roots of a quadratic equation according to the following expressions (7c) and (7d), with A′, B′, and C′ as defined above.

$${τ}_{3} = \frac{- {B}^{′} + \sqrt{{B}^{′2} - 4 {A}^{′} {C}^{′}}}{2 {A}^{′}} \qquad ( 7 c )$$

$${τ}_{4} = \frac{- {B}^{′} - \sqrt{{B}^{′2} - 4 {A}^{′} {C}^{′}}}{2 {A}^{′}} \qquad ( 7 d )$$

If τ₃ is either non-real or negative, τ₃ is then set equal to τ₁. Similarly, if τ₄ is either non-real or negative, τ₄ is set equal to τ₁. From these expressions, the dimension of the shadow abutting ObjectSide_{LowY} is given by the following expression (8).

$$τ = min \{ {τ}_{1} , {τ}_{2} , {τ}_{3} , {τ}_{4} \} \qquad ( 8 )$$

Finally, the two shadow widths t and t are subtracted from the width w to obtain the dimensions of the object 140, resulting in the following set of dimensions for a rectangular prism.

$$\{ l , w - ( t + τ ) , h \}$$

While the above model is presented with the assumption that the light source 130, if present, is co-located with the imaging assembly 120, the present disclosure is not so limited. The model can be adapted to take into consideration the known location of the light source 130 with respect to the imaging assembly 120. For example, if the light source 130 is displaced from the imaging assembly by an amount p along the positive y axis, the adaptation would substitute Y₀ by Y₀−ρ in the equations for τ₁, τ₂, B′, and C′ with no change in the other equations. If the light source 130 is displaced from the imaging assembly 120 by the amount p along the negative y axis, the adaptation substitute Y₀ by Y₀+ρ in the equations for t₁, t₂, B, and C with no change in the other equations.

While the above discussion is presented in the context of FIGS. 2-4 for dimensioning an object having a 3D shape that is generally that of a rectangular prism, the present disclosure is not so limited. The above model may be applied to determine the 3D dimensions of challenging reflectively objects generally, where such 3D dimensions are determined from a merged 3D point cloud.

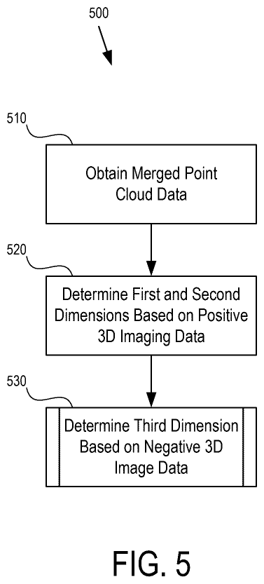

The above operations may be implemented in the form of a dimensioning procedure, for example as performed by a blob tool. FIG. 5 illustrates one example of a method 500 of dimensioning an object on a transport device in accordance with the present disclosure. At operation 510, merged point cloud data may be obtained. In one example, operation 510 includes generating merged point cloud data that includes composite image data based on a plurality of 3D images using a 3D camera assembly (e.g., the imaging assembly 120) as an object (e.g., the object 140) is moved along a transport device (e.g., the transport device 150). Operation 510 may further include capturing the plurality of 3D images themselves using the 3D camera assembly, for example while illuminating the object with a light source (e.g., the light source 130) operatively connected to the 3D camera assembly.

In particular examples, a plurality of 3D images are acquired by the camera assembly of an object, or group of objects, within the FOV. Using this 3D image data, one or more region(s) of interest may be determined (e.g., areas where the height data is above the surface of the transport device). Bounding regions/boxes may be placed around the object(s) in the region(s) of interest. Operation 510 may further include identifying areas having an absence of image data (i.e., areas of negative 3D image data) in the region(s) of interest. This may be accomplished in several ways, for example using segmentation tools or other appropriate vision system tools. In some examples, the absence of image data may correspond to areas where a height value or x-y pixel data is absent. The system may interpret the absence of image data to indicate connectivity or shadowing.

Negative 3D image data may be identified in each 3D image of a set and the 3D images may be combined into a merged point cloud. In some examples, areas of negative 3D image data in one contributing 3D image may be augmented or replaced with corresponding areas of positive 3D image data in another contributing 3D image.

Thus, the merged point cloud data obtained in operation 510 may include connected composite blob data formed of the positive 3D image data and the negative 3D image data in the combined image. Further, operation 510 may also include obtaining information regarding the system configuration, such as camera pose data including or indicating a known position of the 3D camera assembly. In some examples, the system configuration may further include illumination pose data including or indicating a known position of the light source The camera pose data may be obtained from the 3D camera assembly itself, determined from calibration data, extracted from the merged point cloud data, and the like. The illumination pose data may be obtained from the light source itself, determined from calibration data, and the like.

The method 500 further includes an operation 520 of determining a first dimension of the object and a second dimension of the object based on positive 3D image data of the merged point cloud data. In examples, and as noted above, the merged point cloud data itself may provide a sufficiently accurate value of the height of the object above the surface of the transport device. As also noted above, shadows on some contributing 3D images may be canceled out by a lack of corresponding shadows in other 3D images such that the merged point cloud data itself provides information regarding the length of the object in the direction of motion of the transport device. The first and second dimension may be along perpendicular directions to one another.

At operation 530, the remaining dimension (e.g., the width of the object in the direction transverse to the direction of motion of the transport device) is determined based on the negative 3D image data and the composite image data obtained in operation 510. The remaining dimension may be along a direction that is perpendicular to the direction of the first and second dimension. Operation 530 may include various sub-operations to implement the above-described modeling. In one example, operation 530 includes determining a width of a negative 3D image data of the merged point cloud in a lateral direction intersecting the direction of movement of the transport device, and determining the remaining dimension of the object based on the composite image data and the determined width of the negative 3D image data.

Where the plurality of 3D images includes a first 3D image (FIG. 3A) and a last 3D image (FIG. 3B), as illustrated above with regard to the example of FIGS. 3A and 3B, the width of the object may be determined based on a known position of the 3D camera assembly, a first scalar distance between a location of the object in the composite image data and a location of the object in the first 3D image, and a second scalar distance between the location of the object in the composite image data and a location of the object in the last 3D image. The width of the negative 3D image data may additionally or alternatively be determined by determining a first and a second plurality of candidate width values along the third dimension of the object, and determining a first minimum value of the first plurality of candidate width values and a second minimum value of the second plurality of candidate width values. In this regard, for examples, the first plurality of candidate width values can represent candidate values for a first lateral extent of the object along the third dimension, and the second plurality of candidate width values represent candidate values for a second lateral extent of the object along the third dimension that is opposite the first lateral extent.

The third dimension of the object may then be obtained by subtracting the first minimum value and the second minimum value from the composite image data. Determinations in operation 530 may additionally be based on an angle between the direction of movement of the transport device and the direction of the first or second dimensions, thereby to incorporate the angle of rotation of the object relative to the motion of the transport device.

With the object having been dimensioned, various control operations may be performed accordingly. For example, the dimensions of the object may be used to identify the object or an associated object type, to determine if the object is damaged or defective (e.g., by comparing the object to a template), etc. A control signal may be generated to direct the object to one of a plurality of different destinations based on the determined dimension. In one example, the different destinations may be indicative of a transit destination for the object (e.g., whether the object is to be directed to a ground shipping destination, an air shipping destination, etc.). In another example, the control signal and/or different destinations may be indicative of quality control for the object (e.g., whether the object should be rejected and removed from the transport device). Further, a control signal may be generated in response to a determination that the object is damaged or defective.

The method 500 may be performed through the use of a computer program product. For example, a non-transitory computer-readable medium may be provided that stores instructions that, when executed by a processor (e.g., the processor 112) of a vision system (e.g., the vision system 110), cause the vision system to perform various operations including the method 500.

Accordingly, the systems and methods set forth above provide for 3D dimensioning of challenging-reflectivity objects using 3D imaging data in the form of merged point clouds. The above systems and methods provide for much faster dimensioning in such cases, and thus enable transport devices to operate at higher speeds without negatively affecting the dimensioning process. Moreover, the above systems and methods provide significantly reduced processing burden, for example by avoiding repetition of the vision tools (e.g., the blob tool) on additional point clouds.

It is to be understood that the disclosed technology is not limited to the particular embodiments described. It is also to be understood that the terminology used herein is for the purpose of describing particular embodiments only, and is not intended to be limiting. The scope of the present invention will be limited only by the claims. As used herein, the singular forms “a,” “and,” and “the” include plural embodiments unless the context clearly dictates otherwise.

It should be apparent to those skilled in the art that many additional modifications beside those explicitly described are possible without departing from the inventive concepts. In interpreting this disclosure, all terms should be interpreted in the broadest possible manner consistent with the context. Variations of the term “comprising,” “including,” or “having” should be interpreted as referring to elements, components, or steps in a non-exclusive manner, so the referenced elements, components, or steps may be combined with other elements, components, or steps that are not expressly referenced. Embodiments referenced as “comprising,” “including,” or “having” certain elements are also contemplated as “consisting essentially of” and “consisting of” those elements, unless the context clearly dictates otherwise. It should be appreciated that aspects of the disclosure that are described with respect to a system are applicable to the methods, and vice versa, unless the context explicitly dictates otherwise.

Any citations to publications, patents, or patent applications herein are incorporated by reference in their entirety. Any numerals used in this application with or without about/approximately are meant to cover any normal fluctuations appreciated by one of ordinary skill in the relevant art.

Numeric ranges disclosed herein are inclusive of their endpoints. For example, a numeric range of between 1 and 10 includes the values 1 and 10. When a series of numeric ranges are disclosed for a given value, the present disclosure expressly contemplates ranges including all combinations of the upper and lower bounds of those ranges. For example, a numeric range of between 1 and 10 or between 2 and 9 is intended to include the numeric ranges of between 1 and 9 and between 2 and 10.

As used herein, the terms “component,” “system,” “device” and the like are intended to refer to either hardware, firmware, software, software in execution, or any combination thereof. The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming or engineering techniques or programming to produce hardware, firmware, software, or any combination thereof to control an electronic based device to implement aspects detailed herein.

Unless specified or limited otherwise, the terms “connected,” “coupled” and variations thereof are used broadly and encompass both direct and indirect mountings, connections, supports, and couplings. Further, “connected” and “coupled” are not restricted to physical or mechanical connections or couplings. As used herein, unless expressly stated otherwise, “connected” means that one element/feature is directly or indirectly connected to another element/feature, and not necessarily electrically or mechanically. Likewise, unless expressly stated otherwise, “coupled” means that one element/feature is directly or indirectly coupled to another element/feature, and not necessarily electrically or mechanically.

As used herein, the term “processor” may include one or more processors and memories or one or more programmable hardware elements. As used herein, a “processor” may include one or more individual processing units or one or more individual processing cores. Where a processor is referred to as performing a method or operation, various procedures, sub-operations, steps, etc. may be performed by the same processing unit/core or by different processing units/cores, in series or in parallel, in any combination. As used herein, the term “processor” is intended to include any of types of processors, central processing units (CPUs), graphics processing units (GPUs), microcontrollers, digital signal processors, or other devices capable of executing software instructions. For the avoidance of doubt, cloud processing is contemplated in the definition of a processor.

As used herein, the term “memory” includes a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; or an installation medium, such as software media, e.g., a CD-ROM, or floppy disks, on which programs may be stored or data communications may be buffered. The term “memory” may also include other types of memory or combinations thereof. For the avoidance of doubt, cloud storage is contemplated in the definition of memory.

The particular aspects disclosed above are illustrative only, as the technology may be modified and practiced in different but equivalent manners apparent to those skilled in the art having the benefit of the teachings herein. Furthermore, no limitations are intended to the details of construction or design herein shown, other than as described in the claims below. It is therefore evident that the particular aspects disclosed above may be altered or modified and all such variations are considered within the scope and spirit of the technology. Accordingly, the protection sought herein is as set forth in the claims below.

What is claimed is:

1. A vision system for dimensioning an object acted upon by a transport device, the vision system comprising:
a memory; and
at least one processor operatively connected to the memory and configured to:
receive merged point cloud data corresponding to at least a first three-dimensional (3D) image and a second 3D image acquired using a 3D camera assembly, the merged point cloud data including a connected composite blob data formed of positive 3D image data and negative 3D image data,
receive camera pose data including a known pose of the 3D camera assembly, and
determine a width of the object along a first object direction intersecting a direction of motion of the transport device based on at least: the connected composite blob data, a first scalar distance between a representation of the object in the merged point cloud data and a representation of the object in the first 3D image, and a second scalar distance between the representation of the object in the merged point cloud data and a representation of the object in the second 3D image.

2. The vision system of claim 1, wherein the at least one processor is configured to determine the width of the object by:
determining a first plurality of candidate negative 3D image data width values based on the known pose of the 3D camera assembly, a spatial boundary of the connected composite blob data, and at least one of the first scalar distance or the second scalar distance;
selecting a first minimum value from the first plurality of candidate negative 3D image data width values;
determining a second plurality of candidate negative 3D image data width values based on the known pose of the 3D camera assembly, the spatial boundary of the connected composite blob data, and at least one of the first scalar distance or the second scalar distance;
selecting a second minimum value from the second plurality of candidate negative 3D image data width values;
adding the first minimum value to the second minimum value to produce a width of the negative 3D image data; and
subtracting the width of the negative 3D image data from a width of the connected composite blob to produce the width of the object.

3. The vision system of claim 2, wherein the first plurality of candidate negative 3D image data width values and the second plurality of candidate negative 3D image data width values are further determined based on an angle between the direction of motion and the first object direction.

4. The vision system of claim 1, wherein the at least one processor is configured to receive the camera pose data by extracting the camera pose data from the merged point cloud data.

5. The vision system of claim 1, wherein the negative 3D image data comprises a region of the merged point cloud data that defines at least one of an absence of data with respect to the object or a shadow with respect to the object.

6. The vision system of claim 1, further comprising the 3D camera assembly, wherein the at least one processor is a component of the 3D camera assembly.

7. The vision system of claim 1, wherein the 3D camera assembly comprises at least one of a stereo camera, a structured illumination-based camera, a time-of-flight-based camera, or a profiler.

8. The vision system of claim 1, wherein the at least one processor is further configured to:
determine a length of the object in a second object direction perpendicular to the first object direction, based on the positive 3D image data; and
determine a height of the object in a third object direction perpendicular to the first object direction and the second object direction, based on the positive 3D image data.

9. The vision system of claim 8, wherein the at least one processor is further configured to generate a control signal to direct the object to one of a plurality of different destinations based on at least one of the determined length, width, or height of the object.

10. The vision system of claim 8, wherein the at least one processor is configured to determine the length of the object based on a length in the positive 3D image data, a height in the positive 3D image data, and the determined width.

11. The vision system of claim 1, wherein the at least one processor is further configured to:
receive light source pose data including a known pose of a light source; and
determine the width of the object along the first object direction based further on the known pose of the light source.

12. The vision system of claim 11, further comprising the light source.

13. A method of dimensioning an object acted upon by a transport device, the method comprising:
generating merged point cloud data that includes a composite image data based on a plurality of three-dimensional (3D) images using a 3D camera assembly as the object is acted upon by the transport device;
determining a first dimension of the object and a second dimension of the object based on a positive 3D image data of the merged point cloud data; and
determining a third dimension of the object along a lateral direction intersecting a direction of motion of the transport device based on the composite image data and a width of a negative 3D image data of the merged point cloud data.

14. The method of claim 13, wherein
the plurality of 3D images includes a first 3D image and a second 3D image, and
determining the third dimension of the object is based on a known pose of the 3D camera assembly, a first scalar distance between a location of the object in the composite image data and a location of the object in the first 3D image, and a second scalar distance between the location of the object in the composite image data and a location of the object in the second 3D image.

15. The method of claim 13, wherein determining the third dimension of the object includes:
determining a first and a second plurality of candidate partial width values along the third dimension of the object, the first plurality of candidate partial width values being associated with a first lateral extent of the negative 3D image data along the third dimension, and the second plurality of candidate partial width values being associated with a second lateral extent of the negative 3D image data along the third dimension that is opposite the first lateral extent; and
determining a first minimum value of the first plurality of candidate partial width values and a second minimum value of the second plurality of candidate partial width values.

16. The method of claim 15, wherein determining the third dimension of the object includes subtracting the first minimum value and the second minimum value from the composite image data.

17. The method of claim 13, wherein determining the third dimension of the object is further based on an angle between a coordinate system of the transport device and a coordinate system of the composite image data.

18. The method of claim 13, wherein the first dimension of the object is along a first direction, the second dimension of the object is along a second direction perpendicular to the first direction, and the third dimension of the object is along a third direction perpendicular to the first direction and the second direction.

19. The method of claim 13, further comprising illuminating the object with a light source operatively connected to the 3D camera assembly.

20. The method of claim 19, wherein the negative 3D image data includes an area of shadow in the composite image data resulting from the light source.
